(19) United States
(12) Patent Application Publication
(10) Pub. No.: US 2024/0369679 A1
(43) Pub. Date: Nov. 7, 2024

(54) DOPPLER DIVISION MULTIPLEXING

(71) Applicant: Infineon Technologies AG, Neubiberg (DE)

(72) Inventors: Mayeul Jeannin, Augsburg (DE); Dian Tresna Nugraha, Bandung (ID); Farhan Bin Khalid, München (DE)

(21) Appl. No.: 18/650,240

(22) Filed: Apr. 30, 2024

(30) Foreign Application Priority Data
May 4, 2023 (DE) 10 2023 204 161.8

(51) Int. Cl. G01S 7/35; G01S 7/03

(52) U.S. Cl. CPC G01S 7/356; G01S 7/03

(57) ABSTRACT

A radar system transmits using a number of transmitters with respective different phase shift keying schemes, the order of at least one of the different phase shift keying schemes not being a power of two. A radar system may carry out a method which may include correcting for angle estimation distortion resulting from phase components injected as a result of the at least one of the different phase shift keying schemes not being a power of two. The method may further include correcting for rotating phases in the values of the transformed data cube resulting from the order of at least one of the different phase shift keying schemes not being a power of two. Amplitude distortion caused by inter-bin misalignment of the ODDM shifted peaks in the Doppler FFT spectrum may be avoided.

### REFERENCE TO RELATED APPLICATIONS

This application claims priority to German Patent Application 10 2023 204 161.8, filed on May 4, 2023, the contents of which are hereby incorporated by reference in their entirety.

### FIELD

The invention relates to a radar method for use with plural radar transmitters, for example for an automotive application, as well as apparatus for carrying out such a method.

### BACKGROUND

Radar systems have been present in cars for more than a decade and the dominant system architecture at present is still frequency-modulated continuous wave (FMCW) multiple input multiple output (MIMO). As the number of transmit antenna (Tx) grows, there is a need for improved techniques to simultaneously operate the transmitters and carry out the resulting processing. One proposal which attracts attention is slow time phase encoding (STPC).

Another technique of interest is Doppler division multiplexing (DDM) which offers good separation of the transmitters during processing at a realistic computational intensity.

### SUMMARY

There is described a method of processing a radar signal using Doppler Division multiplexing, DDM, the radar signal being transmitted from a plurality of transmitters each using a different phase shift keying scheme, the order of at least one of the different phase shift keying schemes not being a power of two, the method comprising a sequence of acts comprising:
transmitting a radar signal being from a plurality of transmitters, wherein the transmission from each transmitter uses a different respective phase shift keying scheme,
receiving a radar signal at a plurality of receivers, each combination of transmitter and receiver representing a virtual antenna;
converting the received radar signal into digital received radar data;
carrying out a range Fourier transform and a Doppler Fourier transform to convert the received radar data into a Range-Doppler data cube having a plurality of bins each containing a complex number value as a function of range and Doppler; and
DDM decoding the Range-Doppler data cube into received scene data as a transformed data cube having a plurality of bins each containing a complex number value as a function of range, Doppler and virtual antenna;
wherein the method further comprises:
   a) correcting for angle estimation distortion resulting from phase components injected as a result of the at least one of the different phase shift keying schemes not being a power of two;
   b) correcting for rotating phases in the values of the transformed data cube resulting from the order of at least one of the different phase shift keying schemes not being a power of two; and
   c) avoiding amplitude distortion caused by inter-bin misalignment of the ODDM shifted peaks in the Doppler FFT spectrum.

There is also described a radar system for processing a radar signal using Doppler Division multiplexing, DDM, the radar signal being transmitted from a plurality of transmitters each using a different phase shift keying scheme, the order of at least one of the different phase shift keying schemes not being a power of two, wherein the radar signal is transmitted from a plurality of transmitters each using a different respective phase shift keying scheme, received at a plurality of receivers, each combination of transmitter and receiver representing a virtual antenna; the system comprising:
a received radar data input for receiving digital received radar data converted from the received signals at the plurality of receivers;
a range Fourier transform unit connected to the received radar data input and having an output;
a Doppler Fourier transform unit connected to the output of the range Fourier transform unit and an output for plurality of bins each containing a complex number value as a function of range and Doppler; and
a DDM decoding unit connected to the output of the Doppler Fourier transform unit for outputting a complex number value as a function of range, Doppler and virtual antenna;
a centering unit centering the data in the bins of the Doppler Fourier transform unit on zero connected before the input of the Doppler Fourier transform unit or a phase shift correcting unit connected to the output of the Doppler Fourier transform unit.

Those skilled in the art will recognize additional features and advantages upon reading the following detailed description, and upon viewing the accompanying drawings.

### BRIEF DESCRIPTION OF DRAWINGS

The present disclosure is illustrated by way of example, and not by way of limitation, in the figures of the accompanying drawings in which like reference numerals refer to similar or identical elements. The elements of the drawings are not necessarily to scale relative to each other. The features of the various illustrated examples can be combined unless they exclude each other.

FIG. 1 illustrates a radar system.

FIG. 2 illustrates a flow diagram of processing within a processor in a radar system.

FIG. 3 illustrates phases used in subsequent ramps by different transmitters in a radar system.

FIGS. 4 to 7 illustrate data after carrying out a range FFT and a Doppler FFT as a function of range and velocity.

FIGS. 8a, 8b, and 8c illustrate phase compensation.

FIGS. 9a, 9b, 9c and 9d illustrate windowing.

FIGS. 10a and 10b illustrate carrying out a circular shift operation.

FIG. 11 illustrates alignment of phases with bins.

FIG. 12 illustrates signals received from a single target using different PSK orders.

FIGS. 13 and 14 illustrate the received peak power in a reference system, in FIG. 13 showing the phase and amplitude at the peak in the complex plane, and in FIG. 14 the power as a function of value along the Doppler axis.

FIGS. 15 and 16 illustrate the received peak power in a reference system, in FIG. 13 showing the phase and amplitude at the peak in the complex plane, and in FIG. 14 the power as a function of value along the Doppler axis.

FIG. 17 illustrates alternative processing orders.

FIG. 18 illustrates alignment of phases with bins in a different arrangement.

FIGS. 19, 20, 21, and 22 illustrate output signal as a function of azimuth angle using a variety of approaches.

### DETAILED DESCRIPTION

An example Radar system will now be described purely by way of example.

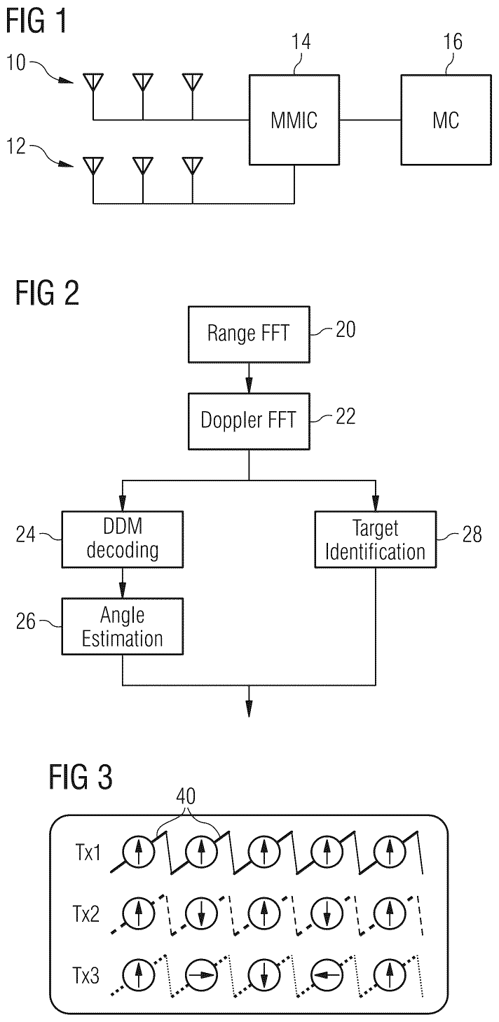

The example radar system of FIG. 1 includes a plurality of transmitters Tx 10 and a plurality of receivers Rx 12. These are both connected to an analog radar processing chip, in the example a monolithic microwave integrated circuit MMIC 14. The MMIC 14 drives the transmitters 10 with a radar signal, collects the received radar signal from the receivers 12, and then carries out an analog to digital conversion to output a digital stream representing the received radar signal to a radar processor 16 which carries out radar processing. The radar processor 16 may be a microcontroller MC.

In alternative examples the MMIC 14 and radar processor 16 may be provided as a single chip, or alternatively as two chips inside a single housing.

The Radar processing chip 16 carries out a number of operations as illustrated purely by way of example in FIG. 2.

The data is input as a data cube in digital form, in other words a data cube having slow time along one axis, fast time along a second axis and the third axis corresponding to the plurality of receivers. A complex number representing the amplitude and phase is stored in each bin of the data cube.

A range FFT 20 along the fast time direction converts the data in that direction into Range data.

A Doppler FFT 22 along the slow time direction is then carried out which converts the data in that direction into Velocity data.

The data cube is then demodulated, in this case by DDM decoding 24, which separates the individual virtual antennae, where each virtual antenna is the signal transmitted from a particular transmitter and received by a particular transmitter. Accordingly, in the example with three transmitters and four receivers there will be twelve virtual antennae.

The azimuth angles, e.g., the directions of the targets, can be calculated by angle estimation 26 using the phase information of the targets at a particular range and Doppler coordinate as a function of virtual antennae.

In parallel to the angle estimation 26, target identification 28 is carried out on the data output by the Doppler FFT 22. For target identification 28, the data is integrated across the antenna direction and then relevant targets identified.

The amplitude and phase values as well as the target direction at range-Doppler positions corresponding to the identified targets are then output for subsequent processing in the microcontroller 16.

These acts can be carried out in hardware, in software, or in software running on dedicated hardware.

It will be appreciated that in a system of this kind each Rx picks up signals from each Tx and so the digital signal passed to the radar processor includes contributions from each transmitter and each receiver. These need to be processed in such a way that the contribution from each pair of transmitter and receiver, known as each virtual antenna, can be separated from each other and correctly processed.

One way of distinguishing the different transmitters is by means of Doppler division multiplexing (DDM), which will be discussed by way of example with respect to FIG. 3, which relates to a system with three transmitters 10, Tx1, Tx2 and Tx3.

In this case, the signal transmitted from each Tx 10 includes a plurality of ramps 40.

In the case of the first transmitter Tx1 each ramp is transmitted with the same phase, indicated by the up arrow, always in the same direction.

In the case of the second transmitter Tx2 each ramp is transmitted with the opposite phase to the previous ramp. Thus, the first ramp is transmitted with a phase +1 (0°), the second ramp is transmitted with a phase −1 (180°), the third ramp is transmitted with a phase +1 (0°), and so on with the phases alternating for each ramp. This may be considered as an example of binary phase shift keying (BPSK) in that there are two available phases, +1 and −1, which may be represented by the phase angles 0° and 180° respectively.

In the case of the third transmitter Tx3 quadrature phase shift keying (QPSK) is used, where the phase of each ramp may be selected from four possibilities, 0°, 90°, 180° and 270°. In the example described, the first ramp is transmitted with a phase of 0°, the second ramp with a phase of 90°, the third ramp with a phase of 180° and the fourth ramp with a phase of 270°.

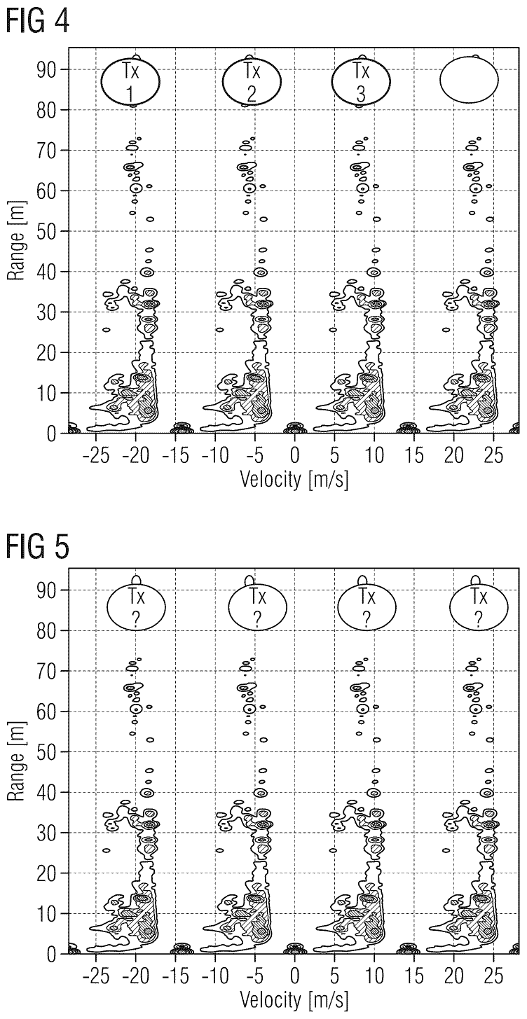

When the signals are processed to create the range-Doppler data cube, as illustrated in FIG. 4, the received signals corresponding to each transmitter are separated in the Doppler direction. FIGS. 4 to 7 each show the data with the Doppler (velocity) axis in the x direction and the range axis in the y direction. FIG. 4 clearly shows the three distinct groups of signals, each corresponding to one of the transmitters. For this reason, the method is known as Doppler division multiplexing as the different phases applied to the transmitters result in outputs separated in the Doppler direction in the range Doppler data cube. In this way, the outputs are readily separated.

Each transmitter needs to transmit using a different phase shift key. It will be appreciated that in the case of four transmitters, the fourth transmitter may transmit using a phase shift keying with 4 or 8 values, 4PSK or 8PSK. FIG. 5 illustrates the received signal in the range Doppler data cube in such an example with 4PSK.

Note that by providing the different phase shifts in the ramps transmitted from the different transmitters, the normal Radar processing carried out to generate a range-Doppler data cube separates out the signals from each transmitter without requiring additional processing.

FIGS. 4 and 5 illustrate an additional consideration. In general, the exact velocity (distance along the x axis of FIG. 5) corresponding to each peak is not known. Thus in the case of FIG. 5, it is not possible to be sure which of the peaks corresponds to Tx1, which to Tx2, and so on. This means that there is ambiguity in the velocity. In the example of FIG. 4, on the other hand, the use of an empty band can resolve this ambiguity. The peak immediately to the right of the empty band is Tx1, the peak to the right of that Tx2, and the peak to the right of that Tx3.

Thus, the approach described above works well for three transmitters as in FIG. 4 but consideration needs to be given as to how the approach can be modified when the number of transmitters rises.

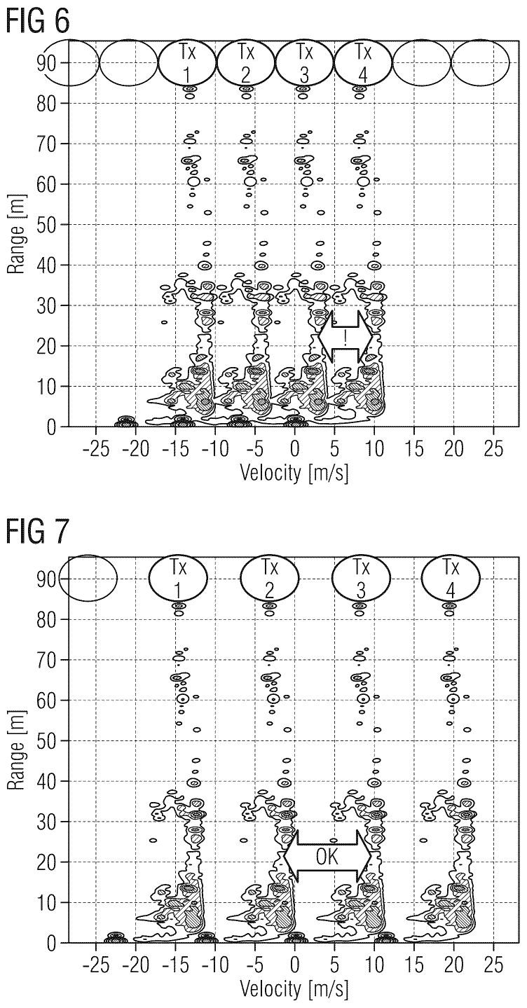

One way of dealing with the issue of identifying which transmitter is which in FIG. 5 is to use an alternative mapping to Doppler space as illustrated in FIG. 6. In this example, an 8PSK scheme is selected giving rise to 8 possible peaks in the Doppler direction, only four of which are used. In this case, two of the transmitters use 8PSK, but with different phase rotations between successive ramps. As may be seen, this example solves the Tx ambiguity problem illustrated with FIG. 5 as each transmitter can be uniquely identified, in the same way that the arrangement illustrated in FIG. 4 resolves the ambiguity with three Tx using a 4PSK scheme with one empty band. The problem is that the four DDM shifted Tx are closer together in the Doppler direction which may lead to overlap and loss of sensitivity.

An alternative way of dealing with this issue is illustrated in FIG. 7. In this case, the maximum ambiguous velocity is selected so that there are five bands across the whole Doppler direction, and the use of an empty band means that each of the transmitters can be reliably identified without excessive overlap in the received signals in the Doppler direction. However, note that in this case the phases are not arranged in a power of 2, but instead each ramp in the signals transmitted from Tx2, Tx3 or Tx4 may take the phase value 0°, 72°, 144°, 216°, or 288°. The sequence of phase values differs for each transmitter Tx2, Tx3, and Tx4 so that the transmitters may be individually identified as they end up at different locations in the Doppler direction in the range-Doppler data cube. This may be described as 5PSK as five possible phase values are taken.

In the following, we will refer to the use of a number of phases which is not a power of two as Odd Doppler Division Multiplexing, ODDM. ODDM brings a number of further calculation difficulties which degrade the received signal unless suitable countermeasures are taken.

The inventors have carried out a detailed review into these difficulties, identified where problems exist, and proposed solutions. These will now be described in some detail, following which an example will be shown demonstrating that the proposed combination of solutions does indeed allow ODDM to be used successfully if the correct precautions are taken as will now be described.

### A) Code Phase Correction

The goal of DDM is to inject a virtual Doppler frequency shift into the transmitted signals which allows the signals received from the different signals to be disentangled in the Doppler direction on carrying out the normal processing.

The difficulty is that providing such phase shifts could also inject unwanted phase components which could affect the angle estimation of targets, as phase is also used for such angle estimation. The reason for this is that starting a phase modulation at 0° does not necessarily mean that the generated code has a 0 phase, as the phase of the signal is the center point of the signal, not the first point. In this context, the center point of the signal is the central point: in a 256 point signal, the center point is the 128^{th} point. By chance, when the DDM order is a power of two, the phase of the center point matches the phase of the first point and so this effect does not occur. Unexpectedly, by applying a number of ramps not commensurate with the PSK order, phase shifts may be introduced.

The inventors have realized that it is possible to inject a suitable phase compensation to correct for this effect either by injecting the phase compensation into the transmitted ODDM signal, or by correcting the phase at a processing level. In other words, instead of transmitting using the five possible phases 0°, 72°, 144°, 216°, or 288°, a constant offset may be applied of +5°, so the different phase values may be 5°, 77°, 149°, 221°, or 293°. Instead of introducing this offset in the transmitted signal, the offset may also be introduced during calculation.

The required phase shift Tx_{corr} in radians is given by the following equation:

$${Tx}_{c o r r} [ rad ] = 2 π \cdot \frac{{N}_{ramps}}{2 \cdot PSK \#} mod ( 2 π )$$

where PSK #is the order of the PSK (5 in the example above) and the number of ramps in a cycle is given by Nᵣₐₘₚₛ. The phase shift required for a specific transmitter is in other words determined by the fractional part of the number of ramps divided by the order of the PSK for the transmitter concerned.

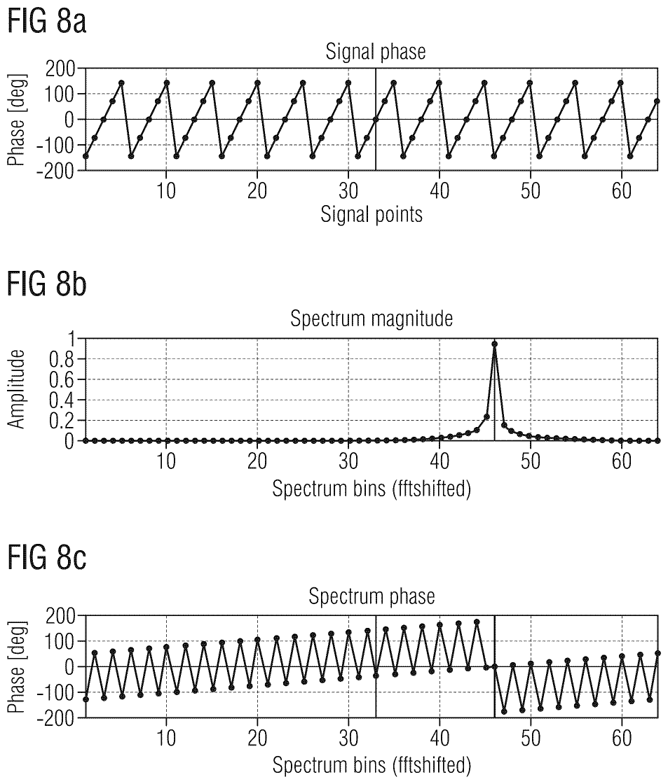

FIGS. 8a-8c illustrate this. FIG. 8a shows the phase applied to each signal point in a 5PSK scheme. The first point (N=0) has a phase of −144°, the second −72°, the third 0, the fourth 72° and the fifth 144° after which the cycle repeats.

FIG. 8b shows the amplitude in the spectrum bins after the FFT and DDM encoding. In this case a peak is visible at bin 47.

FIG. 8c illustrates the applied phase applied to each of the points of FIG. 8b according to the equation above to correct for the code phase effect. Each point in the spectrum bins simply has the appropriate phase shift according to FIG. 8c applied.

### B) Phase Shifts Between Peaks

Phase can be of relevance in radar signal processing in a number of ways. The evolution of the phase of a given range peak over time in the slow time dimension (e.g., between different ramps) gives rise to the Doppler measurement. The phase evolution of a given Range Doppler peak in the spatial dimension gives the Direction of Arrival.

In the case of DDM the phase information of multiple peaks in the spectrum is also relevant as it is used to separate the peaks.

The inventors have realized that if the signal input to the Doppler FFT is not centered then this amounts to analyzing a delayed version of the signal. The effect in the frequency domain then results in a phase rotation over the spectrum. In the case of a power of 2 DDM, the phase rotation has a rate that is a multiple of the FFT length so that repeated peaks suffer from the same phase shift. With ODDM, this is not the case and so the phase shift needs to be corrected.

The inventors propose to correct the phase shift using a window function after the FFT, e.g., applied to the data leaving the FFT, as will now be described.

Firstly, consider the case of a rectangular window, in the pre-FFT domain. The data is over a finite range centered on zero, as the FFT only operates on a particular range of data in the pre-FFT domain, data outside this domain is 0. When the FFT is carried out, the FFT of the rectangular window is a sinc function which spreads the data into neighboring cells. As the sinc function is a real function, no phase shift or spiraling is expected. This occurs because the rectangular window function is centered on zero.

However, if we then use an ODDM with zero padding to increase the length of the data to correspond to the FFT length, such zeros are typically added at the end. This means that the non-zero data is provided only over a window that is not centered on zero, corresponding to a delay, which results in a spiraling effect in the data resulting from the FFT. In other words, the input is essentially a delay by an amount a in the slow time direction x and after a FFT this results in an output that has a phase rotation over the spectrum:

$$f ( x - a ) {\to }^{FFT} {e}^{- 2 π ia ξ} \hat{f} ( ξ )$$

where is the input variable in the Doppler direction.

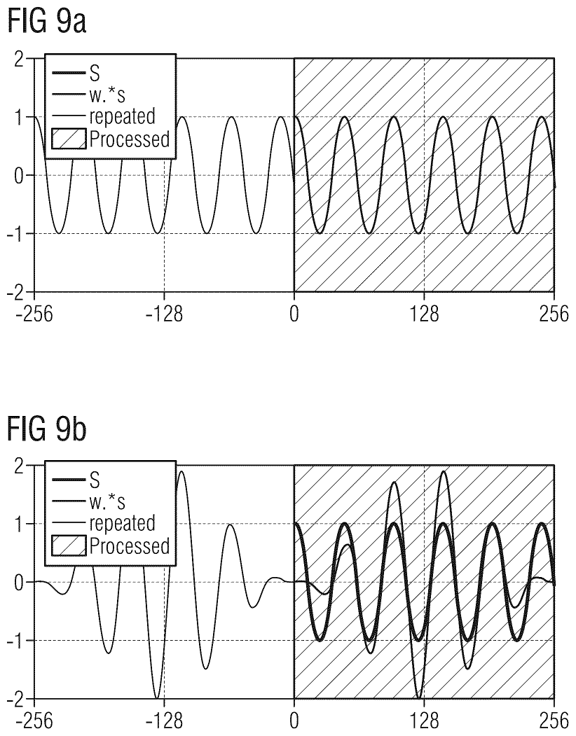

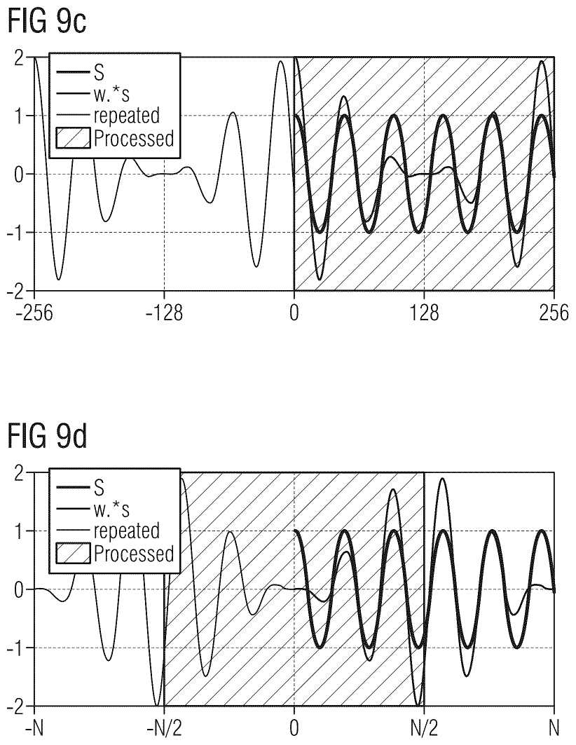

To explain further, FIG. 9a illustrates a standard case using a 256 point FFT. The incoming data, here a sine wave, is simply windowed to have 256 points, the number accepted by the FFT. The FFT implicitly assumes that the signal repeats with a 256 point period: the repeated signal to the left of zero is shown. The problem here is the mismatch at 0: the signal should be smooth throughout without the step in signal value at 0.

As illustrated in FIG. 9b, for this reason a windowing function is provided that is applied to the input data. The windowing function may be a Chebyshev windowing function, for example. This function w is multiplied by the windowing function w to give a signal with greater intensity near n=128 and lower intensity near n=0 and n=256. In this way the function is smooth at 0.

The problem with this approach is that the windowing function is not centered around zero and this leads to the phase shift as set out above.

FIG. 9c illustrates the use of such a windowing function centered around zero, e.g., with the high value near n=0 and n=256. In this case, the use of a suitable windowing function avoids the phase rotation caused by a non-centered windowing function at the cost of a large step at n=0.

The goal is thus to find a solution for achieving both a smooth curve at n=0 and to avoid the phase shift. This may be achieved in practice in two ways, as will now be presented.

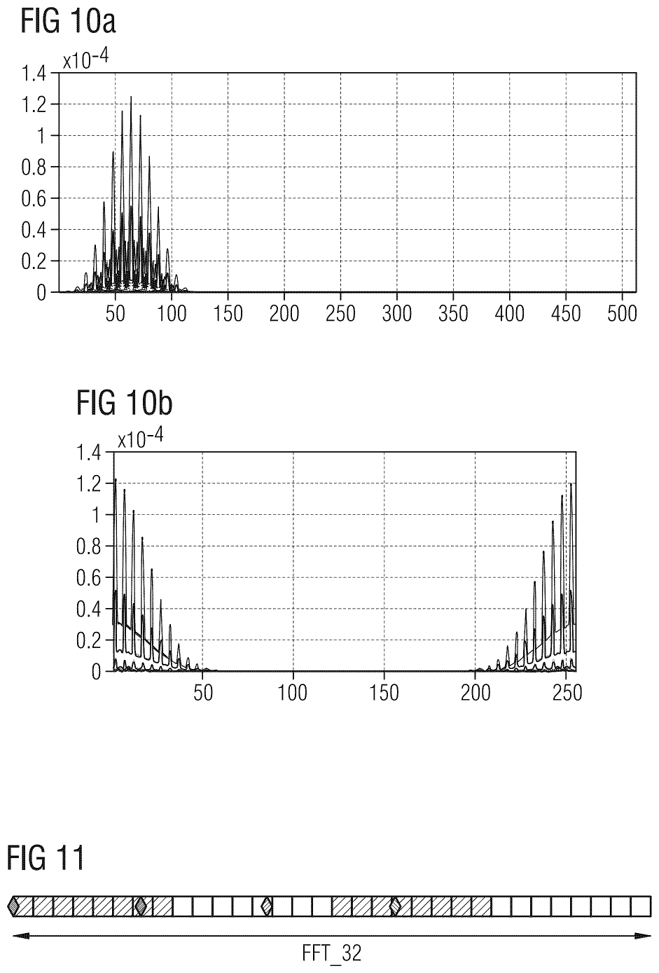

In one solution the input data before the FFT is centered on zero. FIG. 10a shows the input data with classical padding, in which zeroes are added to the end of the data to pad the data before carrying out the Fourier transform. By shifting and centering the padding on zero the input data can be shifted as shown in FIG. 10b which is centered on zero. This padding then removes the effect above: in other words, it is relatively straightforward to pad the data in such a way that the arrangement of FIG. 9d applies.

In this radar application, note that the length of the signal is known a priori, e.g., it is known that n=128. This means that the shift is known. The shift can be carried out at the same time as carrying out windowing as described below in section C).

Alternatively, instead of shifting the data to center the input, it is also possible to multiply each of the output values of the FFT by an exponential to correct the output. Thus, the output can be corrected by multiplying each output value by a corresponding

e^{2πiaξ}

to correct for the shift. Thus, in this case uncorrected data according to FIG. 9a is used but the resulting phase shifts in the final data are corrected by multiplying out.

### C) Scalloping Loss

Another effect will now be described with reference to FIG. 11.

In this case again consider the Example of FIG. 7 with four transmitters using 5PSK.

FIG. 11 illustrates a situation with 32 frequency bins in the phase direction corresponding to the Doppler direction before Fourier transform. 32 is a power of 2 and typically the Discrete Fourier Transform algorithm used us a Fast Fourier Transform (FFT) Algorithm which operates on a number of data points that is a power of 2; such FFT algorithms are much more computationally efficient than general DFT algorithms. However, where there are five phase shifts, it will be noticed that the phase shifts are not equally spaced with respect to the bins, but different values of the five possible phase shifts are aligned differently with respect to the bins. Where a phase is exactly on the bin boundary, the received power may be spread equally between the two adjacent bins; where the phase lies in the middle of the bind more power may be expected in that bin. This leads to amplitude distortion. Of course, in a real case the number of bins is likely to be higher than 32 but the effect will still occur.

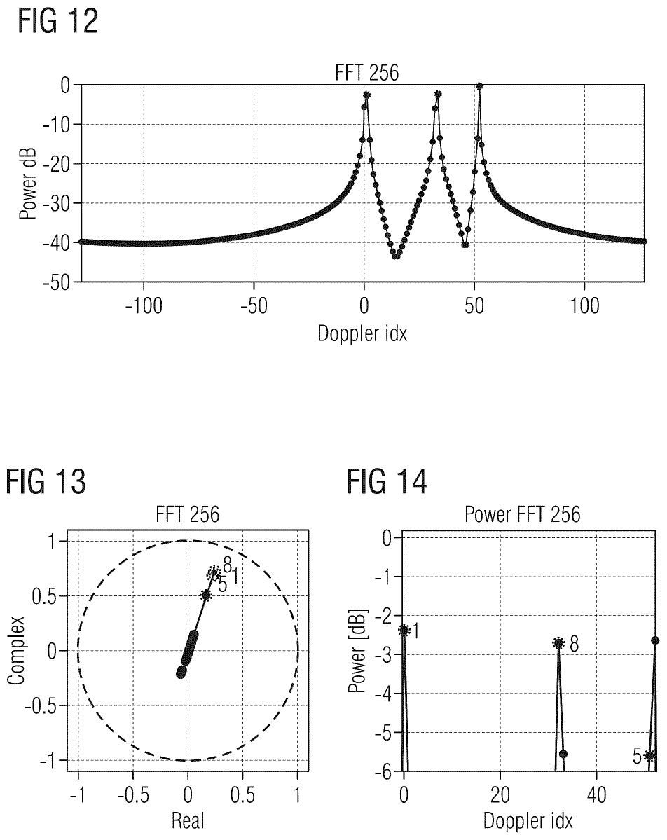

An example of this distortion will be presented with regard to FIG. 12. In this case, Tx1 is unmodulated, Tx2 has 8PSK and Tx3 has 5PSK. In the case of a single target at 0° the same phase and amplitude should be expected for all three peaks. In the example, the FFT length is 256 and then number of ramps 256. See FIG. 11.

Referring to FIGS. 13 and 14, the phases and amplitudes of the three points are shown. From the FIG. 13 it can be seen that there is no resulting phase distortion: all phases are aligned. However, there are different amplitudes shown most clearly in the power graph of FIG. 14 which shows a much reduced value for the 5PSK point caused by this misalignment between bins and FFT.

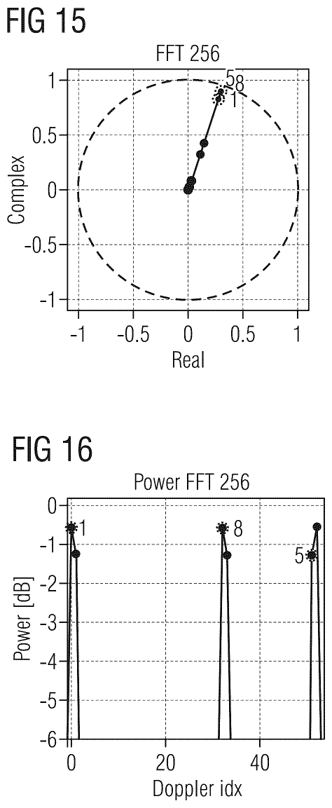

The inventors propose as a solution to use a Chebyshev window function of 100 dB which leads to the results in FIGS. 15 and 16. The reduced power for the 5PSK peak is much reduced and now acceptable.

This window is applied at the Doppler FFT input. The calculation of such windows is further described in F J Harris “On the use of windows for harmonic analysis with the discrete Fourier transform”, Proceedings of the IEEE; Vol 66, No 1, 51-83, 1978 and so will not be described further.

### Introducing Corrections in the Processing Chain

Please note that the measures described above may be included at various points in the data processing chain as required. As set out above, the inventors have realized that three separate corrections are required for ODDM, namely
A Taking care that the odd-PSK code is not injecting a channel phase shift or compensating for it.
B Centering the window function on zero (Bi) or correcting it (Bii).
C Designing the Doppler FFT window to take scalloping loss into account.

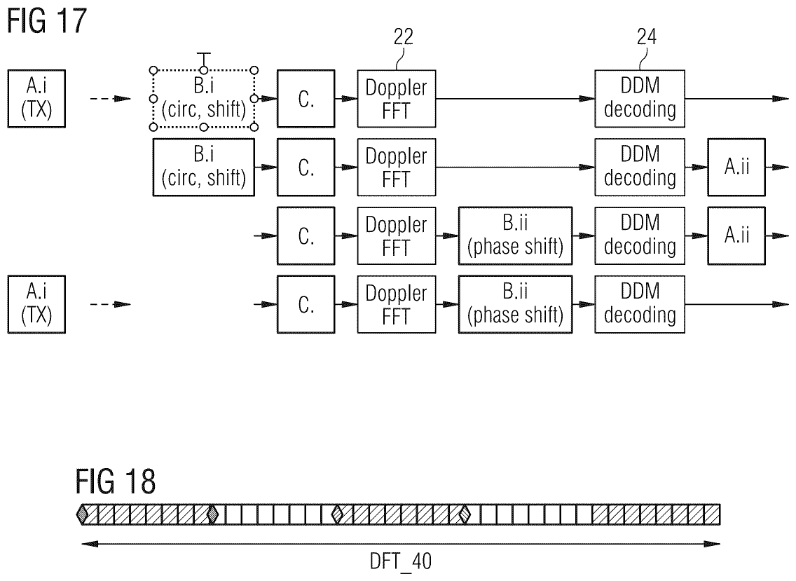

These corrections can be introduced at various points in the processing chain, either before or after Doppler DFT or before or after the DDM decoding is carried out. A variety of suitable orders of carrying out processing acts are presented in FIG. 17.

### Non Power of 2 DFT

An alternative approach may also be used with regard to the scalloping loss and the centered windowing correction, though not the code phase correction. Both of the scalloping loss and centered windowing correction result from the use of a Fast Fourier Algorithm.

The inventors propose addressing both of these issues in an alternative way to that proposed above, namely to use a DFT algorithm not based on a power of 2. Such algorithms are known as mixed radix FFT based on decomposition of the desired length not just by powers of 2. For example, where the length of the FFT is 320 bins, 320 may be factored as 320=64×5=2⁶×5 and the 64 point DFT can be carried out with a classical 64 point radix FFT with a second stage iterating the 5 point DFT. Such an algorithm is known from Xiao, W. Zhao, L. Chen, S. Huang and Q. Wang, “Fast Quasi-Synchronous Harmonic Algorithm based on weight window function—Mixed Radix FFT,” 2016 IEEE International Workshop on Applied Measurements for Power Systems (AMPS), Aachen, Germany, 2016, pp. 1-6, doi: 10.1109/AMPS.2016.7602865. The inventors have realized that the use of such an algorithm may be used to address both the centered windowing correction and the scalloping loss issues.

For example, with a 5 PSK DDM, each transmission phase step is a multiple of 360°/5, e.g., a multiple of 72°. If this is processed using a 40 point DFT, then there are exactly 8 Doppler bins between each transmission step. This means that each phase transmission step is aligned with the Doppler bins in exactly the same way. See FIG. 18 and compare with FIG. 11.

In an alternative example, an 18 PSK modulation scheme results in each transmission phase step being 360/18=20°. If an 1152 point DFT is used, where 1152=64×18, then again each transmission point has the same alignment with the bins.

A preferred DFT length has as many factors as possible, each as small as possible. For example, 1152 is 2\hat{ }7*3\hat{ }2 and because of the powers of 2 this can be supported by a power of 2 FFT hardware accelerator.

Alternatives for the number of transmitters, PSK order, and proposed DFT are presented in Table 1. This table also indicates the memory saving by using the proposed DFT instead of the next available power of two FFT.

TABLE 1

| Transmitters | PSK | DFT*) | Next FFT | Memory saving |
|---|---|---|---|---|
| 4-TX | 5-PSK | 320 | 512 | 37.5% |
| | 6-PSK | 384 | 512 | 25% |
| 6-TX | 7-PSK | 448 | 512 | 12.5% |
| | 8-PSK | 512 | 512 | 0 |
| 8-TX | 9-PSK | 576 | 1024 | 43.75% |
| | 10-PSK | 640 | 1024 | 37.5% |
| 12-TX | 13-PSK | 832 | 1024 | 18.75% |
| | 14-PSK | 896 | 1024 | 12.5% |
| 16-TX | 17-PSK | 1088 | 2048 | 46.875% |
| | 18-PSK | 1152 | 2048 | 43.75% |

### Example

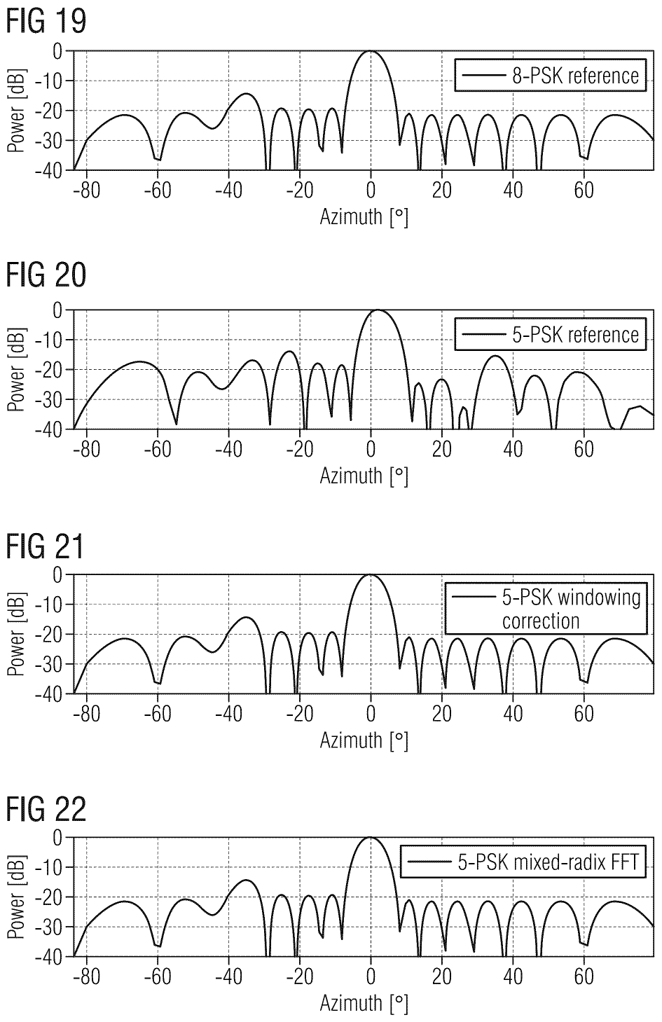

An example of the results achievable with the above approaches will now be described with reference to FIGS. 19 to 22, which shows power measurements as a function of angle in four different scenarios. The scene has a first target at 0° with a radar cross section of 20 dBsm and a second target at −40° with a radar cross section of 5 dBsm. FIG. 19 may be considered to be a reference using an 8 PSK scheme, as overlap is irrelevant in such a scenario: this graph then illustrates the scene in a case where the difficulties of ODDM are not present.

FIG. 20 shows the use of 5PSK without the above corrections. It will be seen that the graph deviates considerably from the 8 PSK graph, showing that the need for correction as described above is significant. For example, note that the main peak is no longer at azimuth 0°.

FIG. 21 shows the graph using a windowing correction. Note that this corrected graph accurately tracks the 8 PSK reference graph and shows that the use of a windowing correction allows for accurate measurement even using ODDM.

FIG. 22 shows the use of the alternative solution involving a mixed radix FFT not using a power of two. Again, the graph accurately tracks the 8 PSK reference and allows for accurate measurement even using ODDM.

Accordingly, it may be seen that the use of the proposed solutions illustrated in FIGS. 21 and 22 allow for accurate measurements to be made even when using a PSK which is not a power of 2.

Although specific examples have been illustrated and described herein, it will be appreciated by those of ordinary skill in the art that a variety of alternate and/or equivalent implementations may be substituted for the specific examples shown and described without departing from the scope of the present invention. This application is intended to cover any adaptations or variations of the specific examples discussed herein. Therefore, it is intended that this invention be limited only by the claims and the equivalents thereof.

It should be noted that the methods and devices including its preferred embodiments as outlined in the present document may be used stand-alone or in combination with the other methods and devices disclosed in this document. In addition, the features outlined in the context of a device are also applicable to a corresponding method, and vice versa. Furthermore, all aspects of the methods and devices outlined in the present document may be arbitrarily combined. In particular, the features of the claims may be combined with one another in an arbitrary manner.

It should be noted that the description and drawings merely illustrate the principles of the proposed methods and systems. Those skilled in the art will be able to implement various arrangements that, although not explicitly described or shown herein, embody the principles of the invention and are included within its spirit and scope. Furthermore, all examples and embodiments outlined in the present document are principally intended expressly to be only for explanatory purposes to help the reader in understanding the principles of the proposed methods and systems. Furthermore, all statements herein providing principles, aspects, and embodiments of the invention, as well as specific examples thereof, are intended to encompass equivalents thereof.

What is claimed is:

1. A method of processing a radar signal using Doppler Division multiplexing (DDM), the method comprising:
transmitting a transmitted radar signal from a plurality of transmitters, wherein transmission from each transmitter uses a different respective phase shift keying scheme, an order of at least one of the different phase shift keying schemes not being a power of two;
receiving a received radar signal at a plurality of receivers in response to the transmitted radar signal, each combination of transmitter and receiver representing a virtual antenna;
converting the received radar signal into digital received radar data;
carrying out a range Fourier transform and a Doppler Fourier transform to convert the digital received radar data into a Range-Doppler data cube having a plurality of bins each containing a complex number value as a function of range and Doppler; and
DDM decoding the Range-Doppler data cube into received scene data as a transformed data cube having a plurality of bins each containing a complex number value as a function of range, Doppler and virtual antenna;
wherein the method further comprises:
(a) correcting for angle estimation distortion resulting from phase components injected as a result of the at least one of the different phase shift keying schemes not being a power of two;
(b) correcting for rotating phases in the complex number values of the transformed data cube resulting from the order of at least one of the different phase shift keying schemes not being a power of two; and
(c) avoiding amplitude distortion caused by inter-bin misalignment of odd DDM (ODDM) shifted peaks in a spectrum of the Doppler Fourier transform.

2. The method according to claim 1, wherein correcting for the angle estimation distortion resulting from the phase components injected based on the at least one of the different phase shift keying schemes not being a power of two comprises:
applying a correction phase directly to an output signal from each of the plurality of transmitters.

3. The method according to claim 1, wherein correcting for the angle estimation distortion resulting from the phase components injected based on the at least one of the different phase shift keying schemes not being a power of two comprises:
injecting a phase correction to the complex number values in the transformed data cube to correct the angle estimation distortion.

4. The method according to claim 1, wherein correcting for the rotating phases in the complex number values of the transformed data cube resulting from the order of at least one of the different phase shift keying schemes not being a power of two comprises:
applying a window function including a circular shift operation to the digital received radar data before the Doppler Fourier transform, the window function centering the digital received radar data on zero.

5. The method according to claim 4, wherein correcting for rotating phases in the complex number values of the transformed data cube resulting from the order of at least one of the different phase shift keying schemes not being a power of two comprises:
applying a calculated phase shift to each value output from the Doppler Fourier transform to compensate for non-centered input data.

6. The method according to claim 1, wherein avoiding the amplitude distortion caused by inter-bin misalignment of odd DDM (ODDM) shifted peaks in the spectrum of the Doppler Fourier transform comprises avoiding amplitude distortion caused by misalignment of the phases of the different phase shift keying schemes with the bins of the Doppler Fourier transform.

7. The method according to claim 4, wherein avoiding the amplitude distortion caused by inter-bin misalignment of odd DDM (ODDM) shifted peaks in the spectrum of the Doppler Fourier transform comprises:
applying a scalloping loss correction window to reduce intensity loss caused by misalignment between one or more phase shifts of the different phase shift keying schemes and the bins of the Doppler Fourier transform.

8. The method according claim 7, wherein applying the window function comprises both windowing and shifting to center the windowed data on zero to apply the window function to center the windowed data on 0, and to apply the scalloping loss correction window.

9. The method according to claim 6 wherein correcting for rotating phases in the complex number values of the transformed data cube resulting from the order of at least one of the different phase shift keying schemes not being a power of two and avoiding errors caused by misalignment of the phases of the different phase shift keying schemes with the bins of the Doppler Fourier transform comprise:
carrying out the Doppler Fourier transform by using a mixed radix Fourier transform on a number of data points not being a power of 2.

10. The method according to claim 8, wherein carrying out the Doppler Fourier transform by using a mixed radix Fourier transform on a number of data points not being a power of 2 comprises:
carrying out the Doppler Fourier transform using a number of bins which is equal to the number of phases of each phase shift keying scheme in that the number of bins is an integer multiple of the number of phases of all of the phase shift keying schemes.

11. A radar system for processing a radar signal using Doppler Division multiplexing (DDM), the radar signal being transmitted from a plurality of transmitters each using a different phase shift keying scheme, an order of at least one of the different phase shift keying schemes not being a power of two, wherein the radar signal is transmitted from the plurality of transmitters each using a different respective phase shift keying scheme, and received at a plurality of receivers, each combination of transmitter and receiver representing a virtual antenna; the radar system comprising:
a received radar data input for receiving digital received radar data converted from received signals at the plurality of receivers;
a range Fourier transform unit connected to the received radar data input and having an output;
a Doppler Fourier transform unit having an input connected to the output of the range Fourier transform unit and having an output for providing a plurality of bins each containing a complex number value as a function of range and Doppler; and
a DDM decoding unit having an input connected to the output of the Doppler Fourier transform unit and having an output for outputting a complex number value as a function of range, Doppler and virtual antenna; and
a centering unit centering data in the bins of the Doppler Fourier transform unit on zero connected before the input of the Doppler Fourier transform unit or a phase shift correcting unit connected to the output of the Doppler Fourier transform unit.

12. The radar system according to claim 11, further comprising
the plurality of transmitters each using a different phase shift keying scheme,
the plurality of receivers, and
a demodulator connected to the plurality of receivers for outputting the digital received radar data.

13. The radar system according to claim 12 further comprising a phase correction data unit connected to the output of the DDM decoding unit.

14. The radar system according to claim 12, further comprising a phase correction unit to each transmitter for applying an angle correction phase shift to the radar signal transmitted from the plurality of transmitters.

15. A radar system for processing a radar signal using Doppler Division multiplexing, DDM, the radar signal being transmitted from a plurality of transmitters each using a different phase shift keying scheme, an order of at least one of the different phase shift keying schemes not being a power of two, wherein the radar signal is transmitted from the plurality of transmitters each using a different respective phase shift keying scheme, and received at a plurality of receivers, each combination of transmitter and receiver representing a virtual antenna; the radar system comprising:
a received radar data input for receiving digital received radar data converted from the received signals at the plurality of receivers;
a range Fourier transform unit connected to the received radar data input and having an output;
a mixed radix Doppler Fourier transform unit connected to the output of the range Fourier transform unit and an output for a number of bins each containing a complex number value as a function of range and Doppler, the number of bins being an integer multiple of the order of each of the different phase shift keying schemes; and
a DDM decoding unit connected to the output of the mixed radix Doppler Fourier transform unit for outputting a complex number value as a function of range, Doppler and virtual antenna, and at least one of:
a phase correction data unit connected to the output of the DDM decoding unit; or
a phase correction unit connected to each transmitter for applying an angle correction phase shift to the radar signal transmitted from the plurality of transmitters.
